(19) United States
(12) Patent Application Publication
(10) Pub. No.: US 2015/0178789 A1
(43) Pub. Date: Jun. 25, 2015

(54) Method and web application for a self-service advertising platform

(71) Applicants: Benjamin Quam, Denver, CO (US); Alex Kronman, Denver, CO (US)

(72) Inventors: Benjamin Quam, Denver, CO (US); Alex Kronman, Denver, CO (US)

(21) Appl. No.: 14/121,744

(22) Filed: Oct. 14, 2014

Related U.S. Application Data
(60) Provisional application No. 61/890,691, filed on Oct. 14, 2013.

(51) Int. Cl. G06Q 30/02; G06Q 20/14; G06Q 50/20

(52) U.S. Cl. CPC G06Q 30/0273; G06Q 30/0277; G06Q 50/20; G06Q 20/14

(57) ABSTRACT

A computer network-based system and method for marketing advertising space in print media facilitating communication between advertisers and publishers. The hardware and software platform allows advertisers to determine from a plurality of publishers those that reach consumers of desired demographic parameters and to determine advertising space availability over a desired time frame (assets) to facilitate establishing an ad campaign. Likewise, the platform permits publishers to enter reader demographics and assets into a database accessible to subscribing advertisers and to download content supplied by advertisers and subsequently to verify the ad placement prior to invoicing for published ads.

### CROSS-REFERENCED TO RELATED APPLICATIONS

This application is a non-provisional application of Application No. 61/890,691, filed Oct. 14, 2013 and claims priority from that application which is also deemed incorporated by reference in its entirety in this application.

### STATEMENT REGARDING FEDERALLY SPONSORED RESEARCH OR DEVELOPMENT

Not applicable

### COMPUTER PROGRAM LISTING APPENDIX

Filed concurrently with the specification and drawings is a CDROM containing the program which, when executed on a computer, carries out the functionality described in the accompanying specification. The program on the compact discs is hereby incorporated by reference.

### FIELD OF THE INVENTION

The invention relates to a novel and useful method and web application for a platform to be used by advertisers, and more specifically, for a method and web application for media advertising management that enables publishers to monetize ad space and for advertisers to access buys in a plurality of outlets and manage campaigns.

### BACKGROUND OF THE INVENTION

College-run media, such as student newspapers or online magazines, are popular and educational tools of teaching journalism. Estimates are that college publications reach over 20 million students weekly. In order to support student-run media, the student-run publication will offer paid advertising space. Student-run media offer unique advertising opportunities for businesses. Student-run media target and reach specific market segments. Student-run media advertising may be more effective, in some cases, than other forms of advertising because it is less expensive, specifically targeted, better received and is a trusted news source. Student-run media reach a coveted demographic, have strong penetration rates and are remarkably sustainable. The efficacy of student advertising is really never in doubt. However, many media properties, not just student-run media outlets, benefit from the present invention.

Currently, in order for advertisers to run advertising campaigns in media, advertisers must either individually contract with representatives at each publication or pay a firm to contract on the advertiser's behalf. However, for multi-state corporations, or even small local businesses in a “college town,” selecting publishers and managing an advertising campaign can be a time-consuming and expensive task. Even when advertisers outsource the contracting for advertising in student-run media they may pay 130% of the publication cost if not more. Therefore, a need exists for an easy-to-use advertising platform that can collect information on media advertising units and convey that information to advertisers while simultaneously enabling advertisers to manage campaigns that encompass multiple buys in multiple issues of multiple publishing media.

Management of creative materials, verification of creative content and processing payments for advertising are time-consuming and expensive problems for most media publishers. For example, a student-run newspaper receives a substantial amount of creative material (i.e., the ads) from advertisers during the course of the year. Managing creative material takes a great deal of organization on the part of any publisher. It is necessary for the editors of publishing media to keep track of the advertisements that are coming in, make sure that the advertisements have the proper dimensions, and bill the advertiser according to their pre-determined schedule. Therefore, a need exists for an advertising platform that allows the publisher of publishing media to manage the flow of creative material in the proper dimensions from the advertisers to the publishers on an alterable, predetermined schedule. Similarly, before an advertisement is run both the publisher and the advertiser want to be sure that the proper ad is running in the proper paper at the proper time. Traditionally, this involves tear sheets which enable a publisher to prove that an advertisement was published. Therefore, there is a need for a self-service advertising platform that can solicit verification documents from publishers to allow verification for advertisements. Likewise, billing and paying for advertising in student-run media can take time away from other important educational goals like selling more ads, writing more articles and studying. Therefore, a need exists for a self-service advertising platform that can manage payment for ads placed after verification.

### SUMMARY OF THE INVENTION

A method and web application for media advertising management according to the principles of the present invention includes an inventory management system for collecting information on media advertising units termed “assets” from publishers and conveying available inventory to advertisers, a campaign management system for allowing advertisers to manage advertising campaigns that encompass buys in multiple issues of multiple publications, a creative material management system for managing the flow of creative materials in proper dimensions from the advertiser to the publisher on a predetermined schedule; a verification system providing a verification document from the publisher, said verification document allowing an administrator to verify that the advertisement is correct; and a payment processing system for managing payment for ads placed after verification.

Further areas of applicability of the present invention will become apparent from the detailed description provided hereinafter. It should be understood that the detailed description and specific examples, while indicating the preferred embodiment of the invention, are intended for purposes of illustration only and not intended to limit the scope of the invention.

### BRIEF DESCRIPTION OF THE DRAWINGS

The present invention will become more fully understood from the detailed description and the accompanying drawings wherein:

FIG. 1A is a schematic representation illustrating the hardware comprising self-service advertising platform of the current invention;

FIG. 1B schematically shows the software systems incorporated in the self-service advertising platform;

FIG. 2 is a schematic representation illustrating the asset workflow diagram according to our invention;

FIG. 3 is a schematic representation illustrating the asset verification diagram according to our invention;

FIG. 4 is a schematic representation illustrating the buyer object structure of our invention;

FIGS. 5A, 5B and 5C when arranged as shown in FIG. 5 are schematic representations illustrating the adding of an asset to a campaign of our invention;

FIGS. 6A, 6B and 6C when arranged as in FIG. 6 are schematic representations illustrating the editing of an asset for a campaign; and

FIG. 7 is a schematic representation illustrating the upload creative to asset of my invention.

### DETAILED DESCRIPTION OF THE INVENTION

This description of the preferred embodiments is intended to be read in connection with the accompanying drawings, which are to be considered part of the entire written description of this invention.

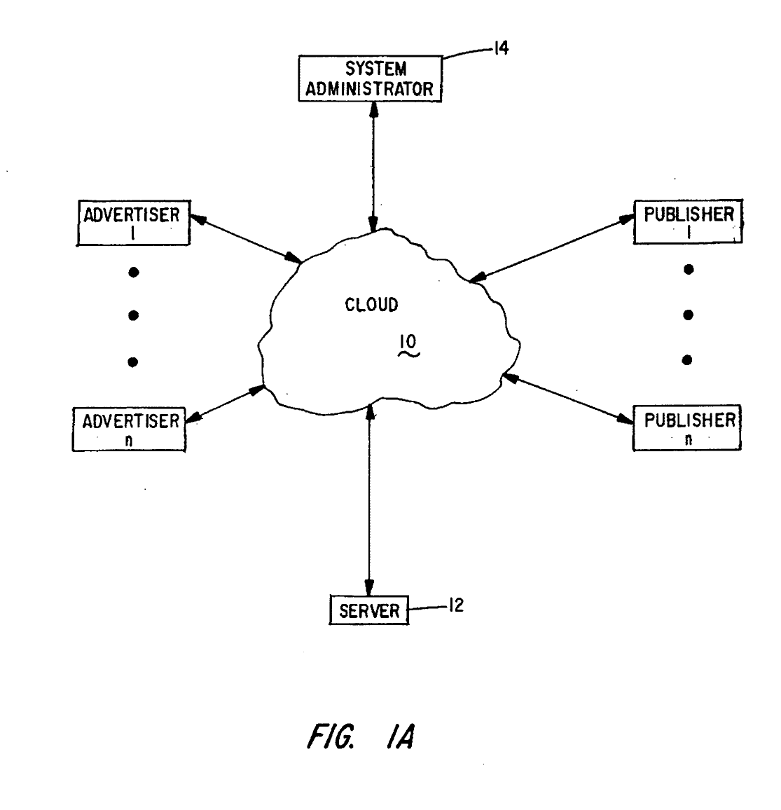

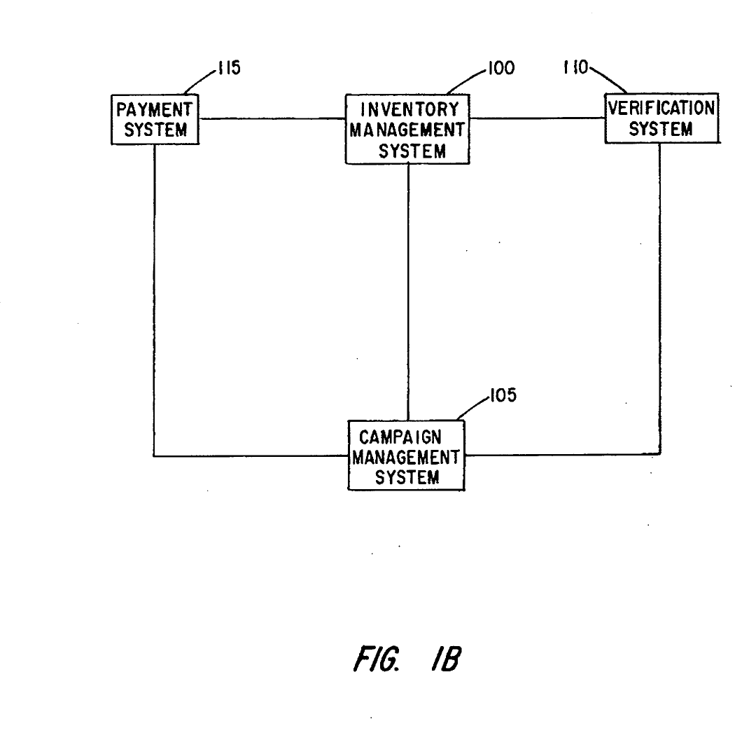

The present invention is a method and system for a self-service advertising platform for advertisers. In a very specific embodiment shown schematically in Figures 1A and 1B, a plurality of publishers each having a computer with a browser uses the browser to request content over a network from a web server 12. FIG. 1A is a block diagram illustrating aspects of an exemplary computer network system which implements embodiments of the invention. In this embodiment the system is implemented in a network environmental 10 that can accommodate one or more advertisers and one or more publishers whose actors are able to input data into the system. Each advertiser and each publisher has a terminal workstation for acquiring information from or entering information to a server 12 via the network 10. Each terminal workstation includes an actor interface of a type well known in the computer industry, e.g. a keyboard, mouse or touch screen. An actor can also communicate via, for example, one or more computers, a computer application or software, such as a web browser, that serves on an actor's local computer or workstation and that connects to the server, as necessary, or a combination of both. The server 12 can be one or more computers or devices on a network that manages network resources. As such, the server can be configured with one or more databases that can be any sort of internal or external memory device of either a read only or a volatile memory type.

The web server thus provides the publishers with a database in which to store information regarding advertising space that the publisher has available for sale. A campaign management system 105 (FIG. 1B) is provided that allows an advertiser, having a computer with a browser, to use the browser to request content over the network 10 from the web server. The campaign management system then provides the advertiser with information from the database regarding available advertising space, and this enables the publisher and advertiser to enter into a contract to purchase and sell the advertising space, and to deliver the print material, i.e., content, to fill the advertising space.

The inventory management system 100 (FIG. 1B) allows multiple publishers to create accounts with the platform whereby publishers store information on media advertising units available with each of their publications. Generally, the publishers submit to the platform all the data about their publication needed for the publishers to market their ad inventory to advertisers. First, the publisher creates an account. The publisher actor (a computer operator) arrives at an introductory page, also known as a homepage. The introductory page links to a “login” page or a “create account” page. The “login” or “create account” page provides a basic registration form having multiple fields, including “publication name”, “school name”, a publisher-specific, publisher-selected password, an email address, and a checkbox to accept the terms and conditions of the platform. After the publisher actor completes the registration form and submits the form to the platform, the platform validates the registration form and creates a publisher record. The validation step checks the registration form against existing and previously entered publisher account information. If the information from the registration form is identical to any existing publisher account information, then a registration error notice is displayed and the browser returns to the introductory page. If the information from the registration form is not identical to any existing account information, then the system generates an account.

After a publisher actor creates and activates its account, the publisher actor can log in to the platform and then edit its publisher account information in a number of fields. Later on, a publisher may update these fields as needed. The publisher account information generally pertains to information about the publisher's school such as its location, type (college, university, etc). The publisher next inputs publication data related to publication, including, for example, dimensions of the paper, dimensions and costs for various-sized ads, and discounts that may be available, circulation and the like.

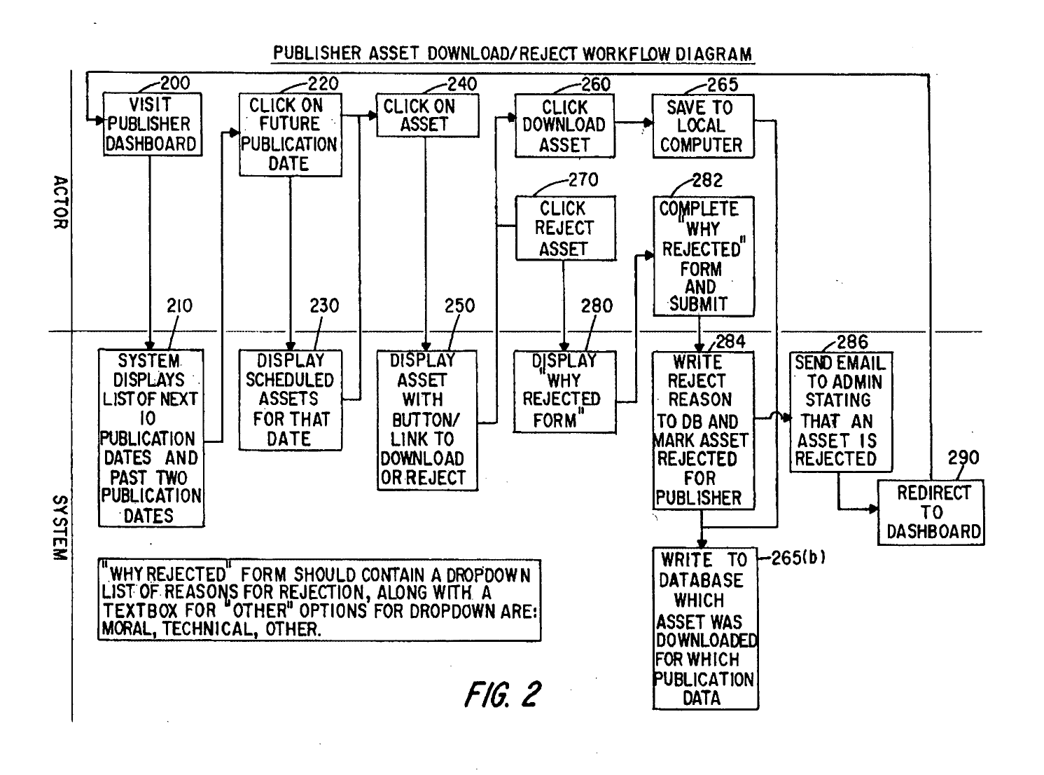

As shown in FIG. 2, the publisher actor is redirected to the publisher dashboard 200 of the inventory management system 100. In the present invention, scheduled advertising space is called an “asset.” The publisher dashboard provides the publisher actor a verification system 110, which functions to provide a verification document to verify that an asset is correct and accepted. The system is programmed to display a list of the current publication date, the next two publication dates and the past two publication dates 210. For past publication dates, two icons appear. The first icon indicates whether verification images have been uploaded. In the present invention, the system by which the invention ensures that an image file has been published to the asset specifications as the advertiser intended is called “verification.” Publishers upload an image from the publication showing the image file as it was published. The second icon indicates whether the system has verified uploaded images and assigned revenue to the publisher. Each icon will have three statuses and a hover event to describe each. The three statuses include (i) not verified; (ii) verified; and (iii) alert—needs attention. A “not verified” status means that the verification system is awaiting the publisher's verification image. A “verified” status means that the verification system has approved and verified the image. The “alert—needs attention” status means that there was either an invalid verification or an improper ad was verified. The publisher dashboard 200 also displays total revenue for the academic year to date, total unpaid revenue earned, total scheduled revenue and a link to view a history report. The total scheduled revenue calculates revenue from scheduled ads that have not yet run.

In carrying out the method of the present invention, a creative material management system is provided for managing the flow of creative materials in proper dimensions. The publisher actor clicks on one of the ten upcoming publications 220. The actor will click on a future publication date and the system will display the scheduled asset for that date 230. In the present invention, an image file to be published (i.e., a print advertisement) is called “creative.” The publisher actor clicks on an asset 240 and the system will display the asset schedule and creative, if the creative exists 250. The system also displays requests for the asset as well as a link to either download the asset 260 or reject the asset 270. When the publisher actor elects to download the asset 260, the publisher actor saves the asset file to his or her local computer 265. Simultaneously, the system writes to a database on the web server 12 (FIG. 1) which asset was downloaded by the publisher for which selected publication date and at what date time 265.

Where the publisher actor elects to reject the asset 270, the system displays a prompt with a dropdown menu selecting reasons why the asset was rejected 280. The actor then completes the rejection form by selecting whether the asset was rejected because of a moral objection, improper dimension or other reasons. The system then writes the reject reason to the database and marks the asset as rejected for that specific publisher 284. The system sends an alert e-mail to the administrator 14 (FIG. 1) stating that an asset has been rejected as reflected in box 286 in FIG. 2. The system then redirects the actor's web browser to the dashboard 290.

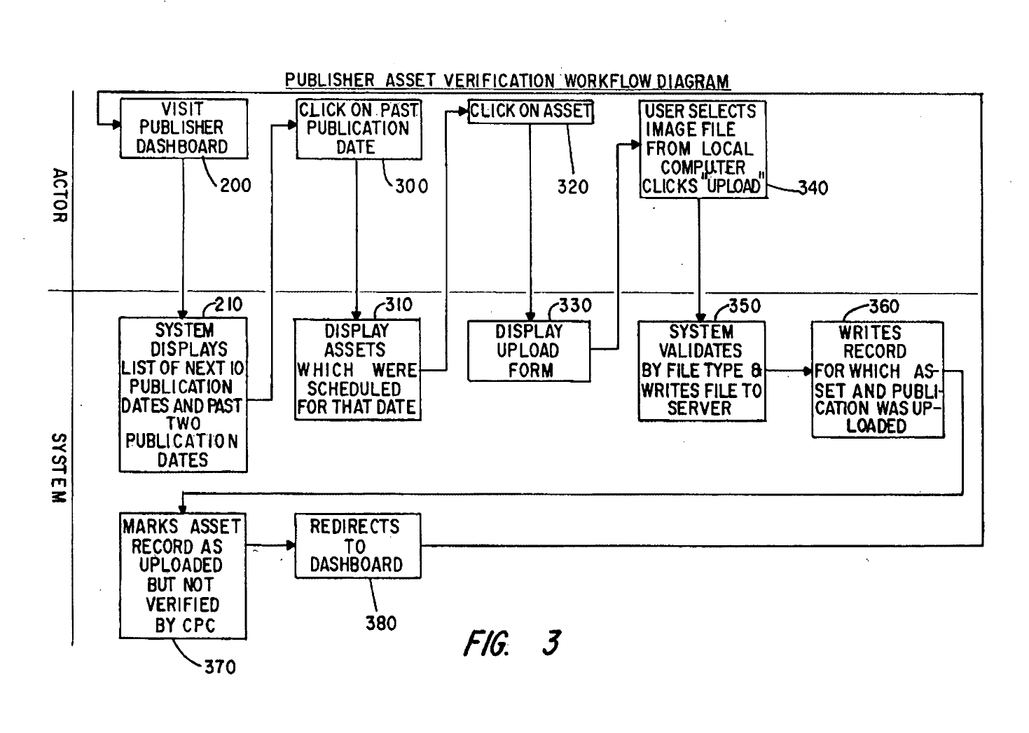

Returning to the publisher dashboard 200 (FIG. 3), the publisher actor can also elect to click on one of the past publication dates box 300. The system displays assets which had been scheduled for a particular past publication date. The actor then clicks on an ad asset be verified 320. The system then displays an upload form ad box 330. The actor then selects an image file from his or her local computer and uploads the file to the system box 340. The system next validates the file type and writes the file to the system's server box 350. The system updates its publisher's database by writing a record for which of the asset and publication was uploaded and verified box 360. The system marks the asset record as uploaded but not verified by the system box 370. The system then displays a modal box, typically expressing the message “thank you” and once the modal box has been closed, the system again redirects the actor to the dashboard box 380.

Buyers, i.e. advertisers, can also access the system by creating a new account, activating the account and logging in to the system. After a buyer has created an account and activated it, the buyer creates a profile in the system, providing the system with certain critical information. After all this has been accomplished, the system redirects the buyer to the buyer dashboard 400. The buyer then creates a new client on the buyer dashboard by clicking a link labeled “create new client” on said dashboard. It is understood that the buyer such as an ad agency can have multiple clients. A client can have multiple campaigns. A campaign can have multiple assets. An asset can have a single creative at a time, but in multiple sizes. Creatives can be swapped out at any point during a campaign. A modal window containing a new client form will pop up asking for the client's name and client notes, and the buyer saves this client information to the advertiser's database and the system creates a record for the client. The modal window is then dismissed and the client list on the buyer dashboard page is refreshed to include the newly-created client 410. The buyer-actor can then click on a client from the buyer dashboard 400 and list a selected client's past and current campaigns for the buyer by campaign title, campaign start and end date, remaining issues to be run, number of gross impressions it has generated to date, and reports on the same 410.

Once on the client page 410, the advertiser actor may create and edit new campaigns represented by box 420. A campaign as used herein, is an object inside a client which is comprised of assets. Buyers can keep different ad lines for separate products within a client. By way of example, a client might have multiple campaigns. To create a new campaign, the actor selects the link “create new campaign” and a modal box displays a form seeking information about the campaign, including the campaign's name and the campaign's advertiser. After the actor fills in the required fields and clicks a “save” button, the system creates a record for the campaign and the modal window is dismissed. The campaign list on the client main page is refreshed to include the newly-created campaign. Similarly, the actor can edit the campaign by clicking the “edit” link for a specific campaign on the client's main page. Again, a modal box is displayed seeking the same information as when the new campaign is created and the edited information may be saved and the system updates the record for the campaign.

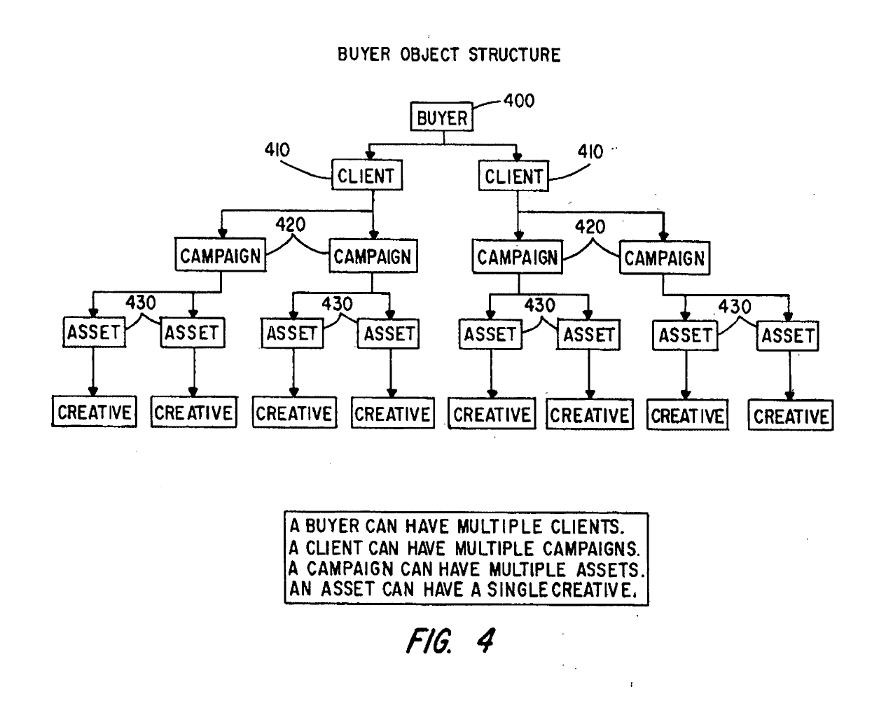

As shown in FIG. 4, the next step is for the publisher actor to add assets to a campaign 430. Assets are considered in terms of newspapers per issue so assets are locked prior to the issue date in which the asset is slated to run. In order to add an asset to the campaign, the actor selects the campaign from the campaign list on the client main page and the system redirects to a campaign main page which lists all assets for the campaign and each asset denotes whether or not it has been confirmed. If an asset has been confirmed, then it may either be “locked” (i.e., a week before it is scheduled to run); the asset has already run in a newspaper; or the creative has been uploaded to the asset.

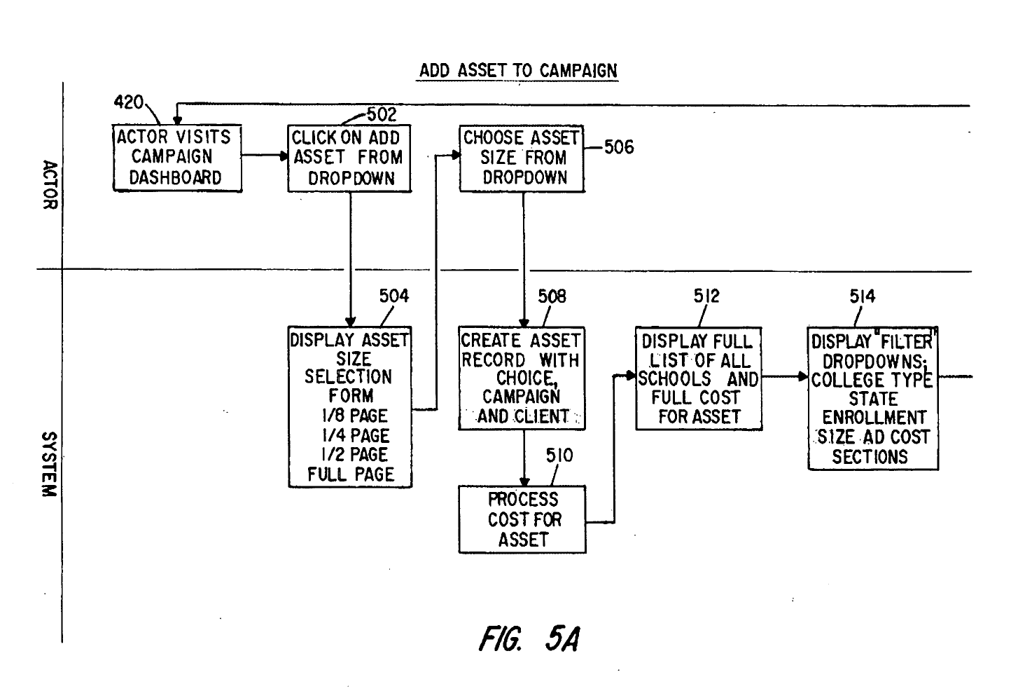

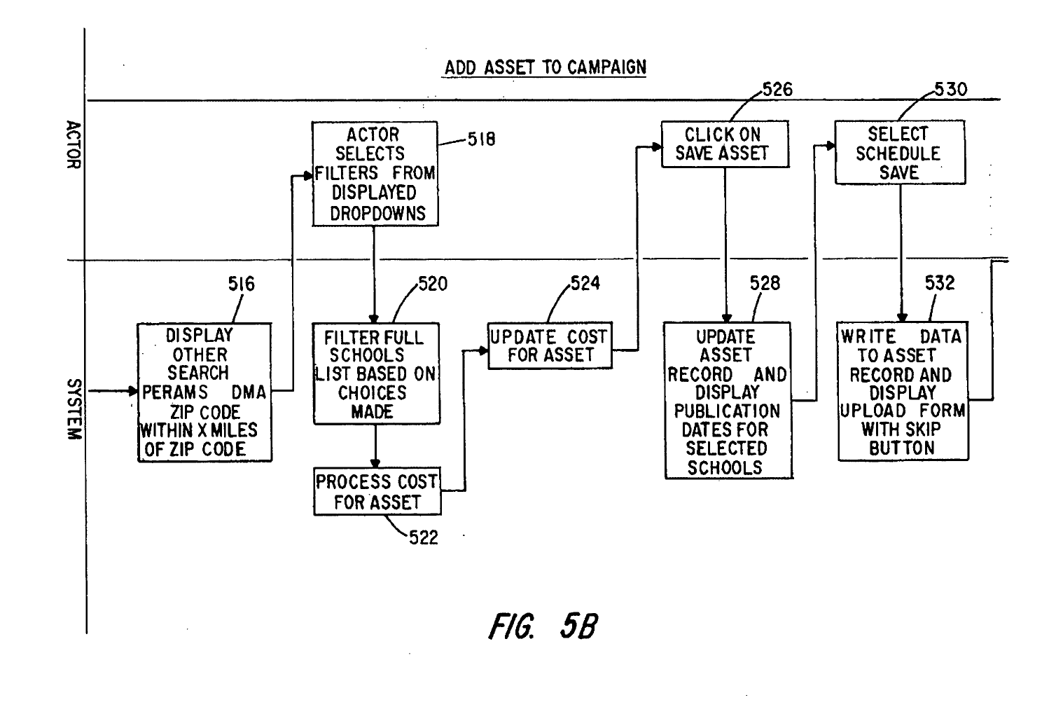

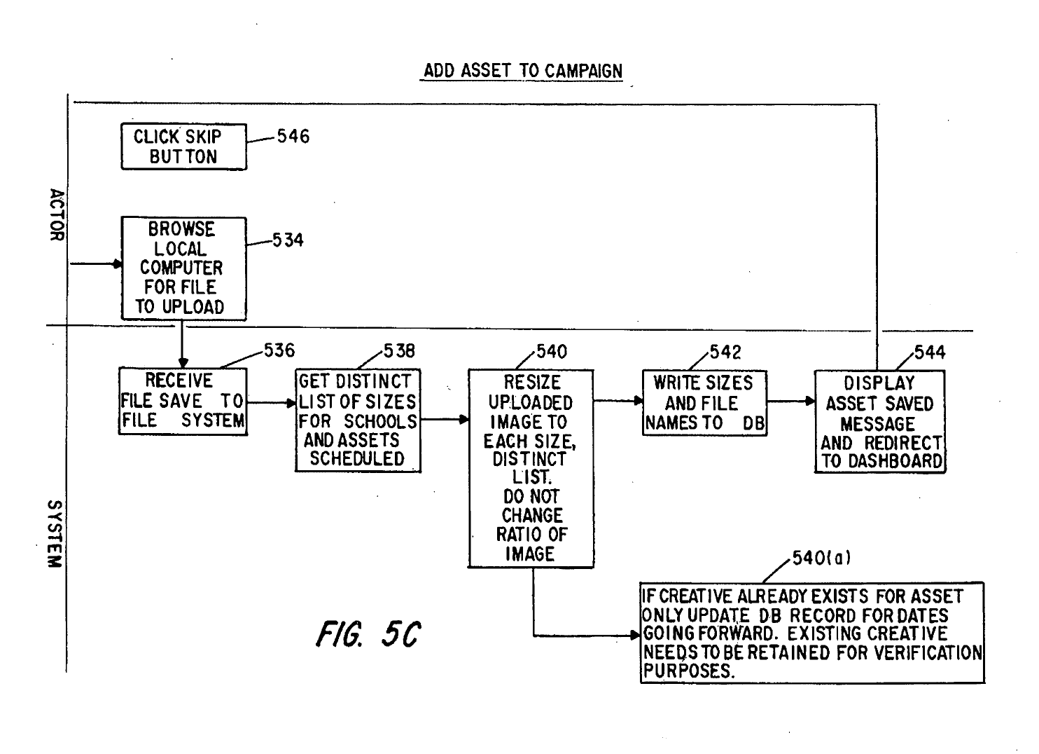

FIG. 5 shows how the advertiser actor can click on the “add asset” link from the campaign main page box 502. The system then displays a form which asks the advertiser actor to name the asset and select from an asset size dropdown menu the size of the asset box 504. The size of the asset may be a one-eighth page, a one-fourth page, a one-half page or a full page 504. After the advertiser actor selects the asset size from the dropdown (box 506), the actor creates an asset record with a choice of campaign and client box 508. The platform displays a full list of all publishers on the advertiser's browser and a full cost of assets, which can be individually selected box 512.

The advertiser actor may select publishers by a series of criteria that filter the publishers so that the buyer may target the most appropriate advertiser actors for a campaign. Box 514 lists these filters that appear in a plurality of dropdown menus including a “college type” menu, a “state” menu, an “enrollment size”, an “ad cost” filter and a “section” filter. The “college type” dropdown includes options of “no preference,” “four-year public schools,” “four-year private schools” and “two-year public schools.” The “state” dropdown menu leads with a “no preference” but includes all fifty standard U.S. states. The enrollment size dropdown menu includes options from “no preference” all the way up to “40,000 and above” for enrollment. The “section list” allows the buyer to select which section of the publication they wish their advertisement to run, including for example, a “no preference,” “sports,” “opinion,” “news,” “features,” “arts and entertainment” and “science” section. As costs well depend on section choices. The system then asks for other search parameters including designated marketing area map, zip code or within certain miles of a zip code box 516. The advertiser actor then selects which filters from the aforementioned displayed drop downs he wants to use 518. The system then filters the full school list based on choices made by the actor from the dropdown menu box 520. As each selection is made, a campaign cost value is calculated (box 522) and displayed (box 524) so that the buyer knows how much money will need to be spent with each change to the schedule.

After the actor has selected its publisher list from the filters and the system calculates the costs for the asset and displays the cost of assets and the actor is satisfied with those costs, he then saves the assets (box 526) and the system creates an asset record using the entered information and displays publication dates for each of the publishers selected box 528. The system now allows the actor to choose the date range for each asset box 530 and the system writes the data to the asset record and displays the uploaded form with a skip button box 532. The advertiser actor can then upload a file with the asset from the advertiser actor's local computer 534. The platform receives the asset file and saves it to the publisher's database 536. The platform generates a distinct list of sizes of schools and assets scheduled box 538. The platform resizes the asset file image to each size on the distinct list 540. The platform will not change the ratio of the image 540. If creative already exists for an asset, the platform will only update the database record for dates going forward 540. The platform writes the ad sizes and file names to the database 542. The platform displays an “asset saved” message and redirects to the dashboard 544.

Meanwhile, the system operates to update the price based on the number of issues the asset is scheduled to run. The platform displays a confirmation dialog box with a summary of creative schedule. The buyer actor may either return to a “search result” page by clicking “cancel” on the confirmation dialog box, or update the asset record. When the system updates the asset record, the creative will run until the end of the campaign unless the buyer actor uploads a new creative, or the buyer actor cancels the campaign. If the buyer actor uploads a new creative, the platform saves the old creative to reference for new verification. The platform records the date the old creative ran.

The platform displays a “creative upload” form, which allows the buyer actor to elect to upload creative or not. If the buyer actor elects to upload creative, the platform redirects to the creative upload form 534, and redirects the actor to the list of assets for the campaign.

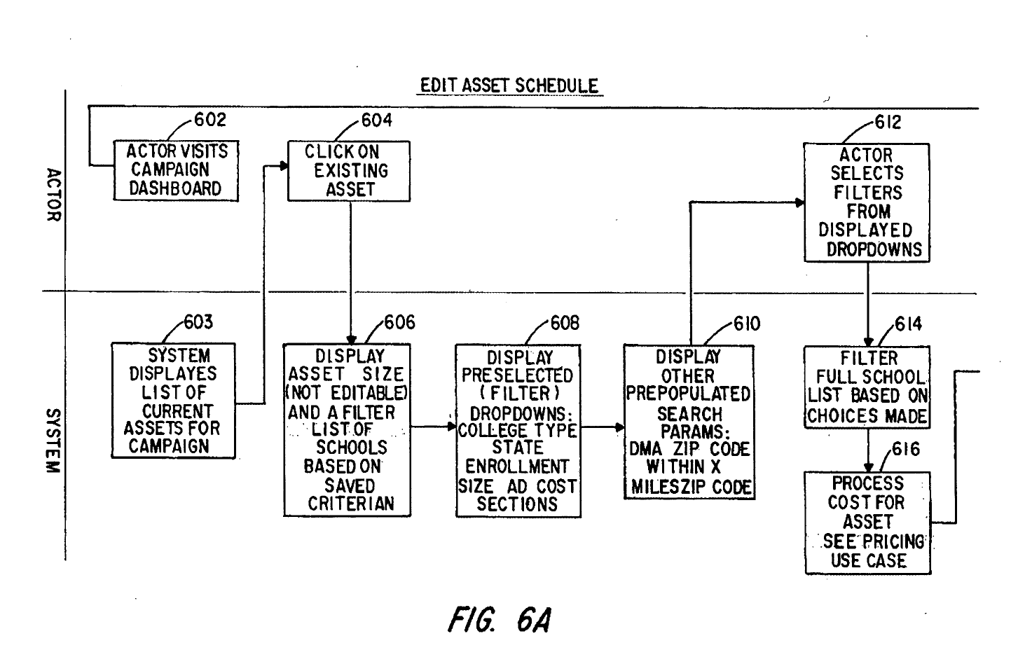

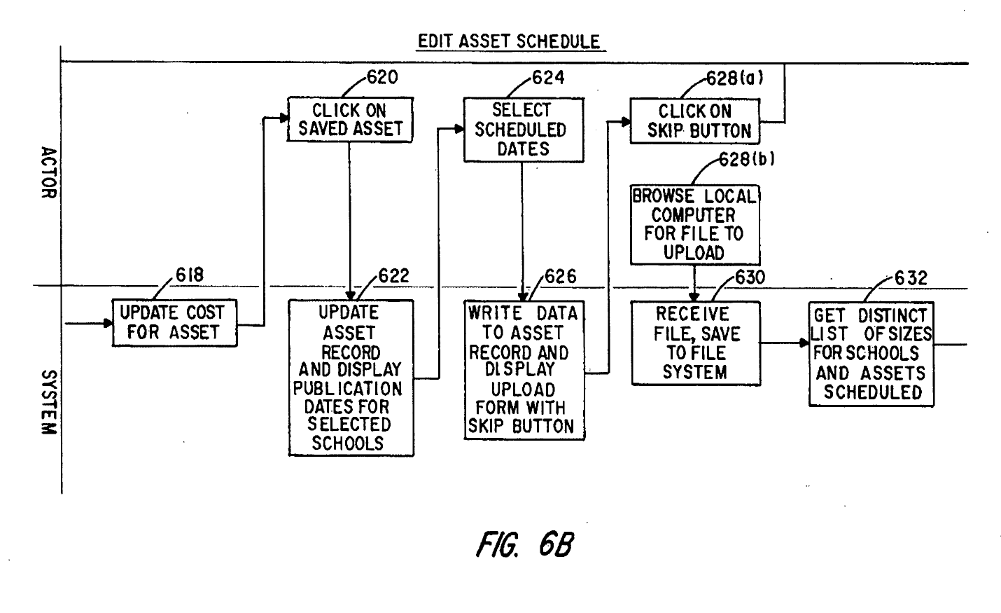

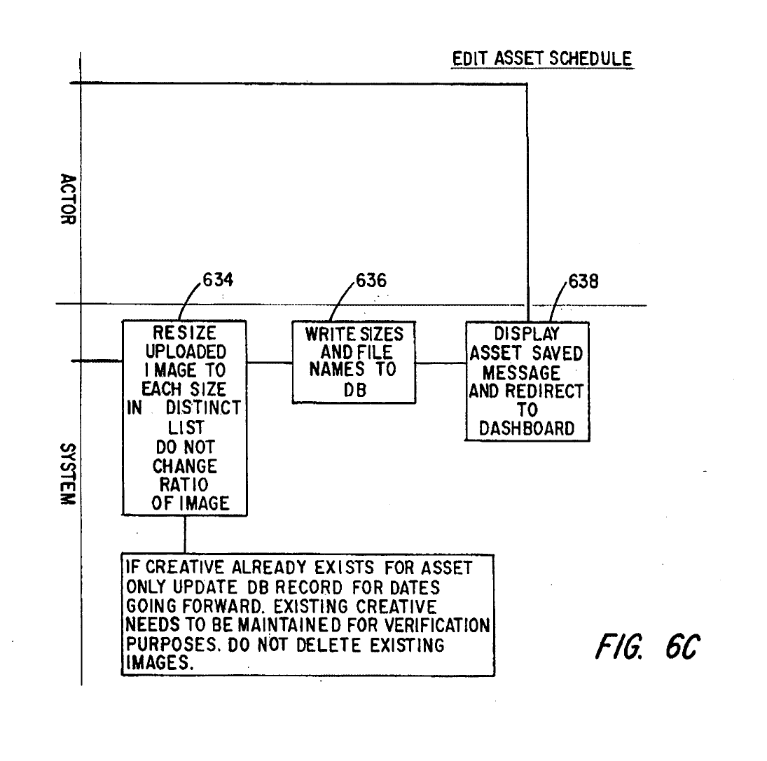

FIG. 6 demonstrates how an actor may edit assets on the campaign. An asset cannot be edited if it is “locked.” A locked asset is any discrete, “scheduled” asset that is less than one week from publication. The asset is designated as scheduled when the buyer completes all necessary inputs to create an ad (including ad size, desired publications, and schedule) and selects “Buy Ad.” To edit an asset, the actor visits the campaign dashboard at box 602 and the platform displays the list of current assets for the campaign box 603. Each asset link on the list of current assets denotes whether the asset has been scheduled for publication. After the list of current assets for the campaign has been displayed, the actor can click on a link of each asset box 604. Each asset on the list is displayed as a hyperlink. When an actor clicks on an asset link, the system displays a form with auto-populated fields populated from the asset record. The fields include the name of each asset, the asset size and a filtered list of publishers based on saved criteria box 606. The platform then displays drop-down menus allowing the advertising actor to filter the publishers (box 608) including college type, state, enrollment size, ad costs and sections. The platform also displays additional search parameters including zip codes and publishers within a predetermined distance from a zip code, box 10. The actor then selects the desired filters from the displayed drop down menus 612. The platform filters the full school list based on the criteria selected from the drop down menus, box 614. As each school or drop down is changed by the actor, the system updates the cost of the asset in real time as reflectedly boxes 616, 618.

The advertiser actor then saves the asset box 620. After the advertiser actor saves the asset, the platform updates the asset record and displays publication dates for the selected schools box 622. The actor then selects the date range he wishes the asset to run box 624 and the platform writes data to the asset record, and a confirmation dialog appears with a summary of the advertising schedule box 626. From the confirmation dialog screen the actor may cancel or skip editing the asset and the platform returns to the campaign dashboard page box 602. However, if the actor elects to move on, he clicks “ok” and the platform updates the asset record. The advertisement will then run in the selected publication until the end of the campaign unless a new creative is uploaded. When the advertiser actor uploads new creative, the platform saves the old creative for the purpose of referencing the creative for verification. The platform will record the dates the old creative ran. The new creative will run until the end of the campaign or another creative is uploaded.

A verification system 110 (FIG. 1B) is provided for digitally supplying a verification document from the publishers to show that a creative has been published. The platform displays a form on the advertiser actor's web browser allowing the advertising actor to upload creative. If the advertising actor elects to upload creative, a creative upload form is displayed which enables the advertising actor to browse the actor's local computer (box 628b) for creative to be uploaded. The advertising actor selects the creative to be uploaded and the platform receives and saves the creative to the system, box 630. The system filters the uploaded file by type (i.e., .jpg, .pdf., .tif). The platform checks the dimensions of the uploaded file and computes a ratio of length and width of the advertisement. The platform gathers a list of advertising sizes for publishers and assets scheduled, box 632. Alternatively, an advertiser may upload four creative corresponding to the four most common newspaper dimensions. Next, the platform resizes the uploaded image file for each size in the list of advertising sizes 634. The platform will not change the ratio of the image 634. The platform then writes the size of the uploaded image file and file name to the database, box 636. The platform now displays a message indicating that the asset has successfully saved and redirects the browser to the campaign dashboard, box 638.

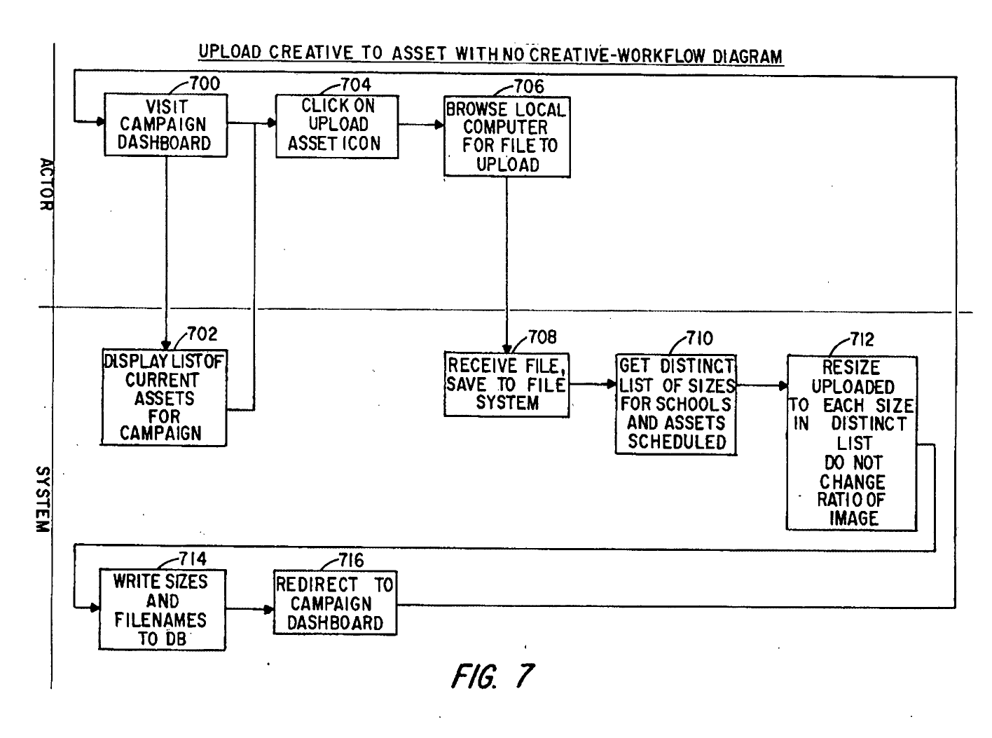

FIG. 7 shows how the platform uploads creative to an asset, either when the advertising actor initially adds the asset to the campaign (as in FIG. 5), or edits a campaign (as in FIG. 6). To upload creative to the asset when no creative has been previously uploaded, the advertising actor visits the campaign dashboard, box 700. The platform displays a list of current assets for the campaign box 702. The advertising actor then clicks on a link for a particular asset that the actor wants to add creative to box 704. The platform displays a form including an upload dialog which allows the actor to browse the local computer for a file to upload to the platform box 706. The upload dialog also includes an upload button for the actor to click on after the actor has browsed his local computer and selected the upload creative file. The platform filters the file type to only allow specific file types (e.g., .jpg, .pdf, .tif). The platform receives the filtered upload creative file, and saves it to the database box 708. The platform generates a distinct list of advertising sizes for each publisher and assets scheduled box 710. The platform then checks the dimensions of the upload creative file and computes the ratio of width to height. The image of the upload creative file is then resized to the size of each size in the list of advertising sizes box 712. Under prior art ad placement methods, ad placement managers and layout specialists had to adjust the ratio and size of each ad image individually, while attempting to preserve the aesthetic integrity and intent of the ad image. In the system of the present invention, the platform simplifies this process. The platform uses inputs from member publications to select the ad images for the four standard newspaper dimensions, i.e., tabloid, broadsheet, 8.5×11 and 10×10. When an ad image has been uploaded the platform will update the database to record the sizes and file names for the image of the uploaded creative file box 714. The platform displays a message indicating success, and redirects the actor to the campaign dashboard box 716.

The platform also includes a payment processing system 115 (FIG. 1) that enables advertisers to submit payment via the interne for the ads that are placed. A Buyer Reporting feature to generate reports for buyers regarding gross impressions, cost per impressions, total circulation of ads, etc. Additionally there are admin features for operating the platform.

The present invention lends itself to Real-time bidding (RTB) where a typical transaction begins with a publisher triggering a bid request that includes various pieces of data including, but not limited to, demographic information and available assets. The request goes from the publisher to the platform of the present invention which submits it and the accompanying data to multiple advertisers who automatically submit offers in real time to place their ads. The advertisers bid on each ad asset as it is served and the asset goes to the highest bidder.

This invention has been described herein in considerable detail in order to comply with the patent statutes and to provide those skilled in the art with the information needed to apply the novel principles and to construct and use embodiments of the example as required. However, it is to be understood that the invention can be carried out by specifically different devices and that various modifications can be accomplished without departing from the scope of the invention itself.

What is claimed is:

1. An advertising management method comprising the steps of:
a. providing a computer network including a plurality of advertisers' computers available to a plurality of advertisers, a plurality of publishers' computers available to a plurality of publishers and a server accessible via a global network by the advertisers' computers and the publishers' computers;
b. providing a first database on the server storing for each of the plurality of publisher's demographic and asset availability information pertaining to their respective publications, and pricing information relating to each available asset;
c. providing a second database on the server for storing contact and billing address information for the plurality of advertisers;
d. programming the server so that advertisers' computers can access the first database via the computer network and import said contact and billing information and uniquely select one or more of the plurality of publishers whose demographics and asset availability meet an advertiser's predetermined criteria;
e. transmitting over the computer network creative content from the advertiser's computer to publishers selected in step (d);
f. publishing the creative content of steps (e) in accordance with an asset selected by the advertiser; and
g. sending a validation copy of the published content and a billing statement to the advertiser making the selection of step (d)

2. The advertising management method as in claim 1 wherein said publishers are college newspapers and said advertisers are entities seeking to sell goods or services to college students.

3. The advertising management method of claim 1 wherein any of the plurality of advertisers may transmit creative content applicable to multiple ones of the advertiser's clients and multiple campaigns of the advertiser's clients over the computer network to any publishers found in the first database.

4. The advertising management method of claim 3 and further including the step of automatically providing notification to an advertiser in the event of failure of the advertiser to provide creative content to the publisher by a predetermined deadline in advance of a scheduled publication date.

5. The advertising management method of claim 3 and further including the step of automatically notifying a publisher of a need to provide an advertiser with a verification image of an advertisement for approval within a predetermined number of days prior to a scheduled publication date.

6. The advertising management method of claim 2 wherein said demographic information includes college type, location, enrollment size, and advertisement costs based on ad size and page location and makeup of advertisement.

7. The advertising management method as in claim 1 wherein the server is available to a system administrator's computer and further including the step of:
a. comparing at the system administrator's computer an original creative from a given advertiser to verification image from a selected publisher and upon detecting a match transmitting over the network an invoice to said given advertiser.

8. The advertising management method as in claim 7 and further including the step of notifying the selected publisher when the verification image from the selected publisher fails to match the original creative from the given advertiser such that the selected publisher can upload a different verification image.

9. The advertising management method as in claim 1 wherein step (g) further includes sending a billing statement to the advertiser making the selection of step (d).
